(19) United States
(12) Patent Application Publication
(10) Pub. No.: US 2011/0022348 A1
(43) Pub. Date: Jan. 27, 2011

(54) METHOD AND APPARATUS FOR DECIDE VERTICAL TRAVEL CONDITION USING SENSOR

(75) Inventors: Kwon Soo Lee, Gyeonggi-do (KR); Yong Kwan Park, Seoul (KR)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: THINKWARE SYSTEMS CORPRATION, SONGPA-GU, SEOUL (KR)

(21) Appl. No.: 12/599,956

(22) PCT Filed: Jun. 25, 2007
(86) PCT No.: PCT/KR07/03058

§ 371 Date: Nov. 12, 2009

(30) Foreign Application Priority Data
May 14, 2007 (KR) 10-2007-0046559

(51) Int. Cl. G01P 15/00; G06F 15/00; G01C 9/00

(52) U.S. Cl. 702/141; 702/154

(57) ABSTRACT

A method and apparatus for determining a vertical driving state using a sensor which determines the driving state according to a gravity change of a moving object by using an acceleration sensor are provided. The method of determining a driving state using a sensor includes: reading a sensor output signal according to a gravity value of a moving object while being driven, from a sensor which senses a gravity value of the moving object with respect to a direction of gravity; and determining whether the moving object is in a level driving state or inclining/declining-slope driving state by comparing the read sensor output signal with a predetermined reference range.

### FIELD OF THE DISCLOSURE

The present disclosure relates to a navigation system, and more particularly, to a method and apparatus for determining a vertical driving state using a sensor which determines the driving state according to a gravity change of a moving object using an acceleration sensor.

### BACKGROUND OF THE DISCLOSURE

Generally, a navigation system is a system which provides information for driving of a transportation device, such as a vehicle, using an artificial satellite. The navigation system is automatic.

A typical navigation system is configured into one terminal and includes a storage medium to store map data. Also, the navigation system includes a Global Positioning System (GPS) receiver to receive GPS signals.

The navigation system calculates a location of a vehicle, informs a user of a current location of the vehicle based on the calculated location of the vehicle. Also, the navigation system routs an optimal path from the current location to the user's desired destination and guides the user to the desired location, providing the user with various types of associated information along the path.

A method of calculating a location of a vehicle receives location data from a GPS satellite using a GPS receiver, and calculates the current location of the vehicle based on the received location data.

Another method of calculating a location of a vehicle calculates the current location of the vehicle using a gyro sensor and an acceleration sensor, which are installed in the vehicle. In this instance, the other method receives GPS signals, calculates the current location of the vehicle based on the received GPS signals, and corrects the calculated current location based on results detected by the gyro sensor and the acceleration sensor.

Also, a slope value of a sensor is determined using the acceleration sensor and an inclination of vehicle is determined based on the determined slope value. For this, the acceleration sensor is vertically mounted in a front/side/bottom surface of vehicle. The condition that an output value of the acceleration sensor is set as an initial value is required when a vehicle is in a horizontal state. Under the condition, when the vehicle is stopped, and a slope value of the vehicle may be obtained by using an output value of the acceleration sensor.

However, while being driven, a gravity value of the vehicle frequently changes due to the effect of other acceleration values of the vehicle, e.g. acceleration/deceleration, vibration due to a road surface, vibration of the vehicle's body, and the like. Accordingly, a slope of vehicle may not be ascertained.

Although an inclination of vehicle may be determined when a vehicle is stopped, a slope of vehicle due to a gravity change may not be determined while being driven, since an output value of an acceleration sensor is minute.

### SUMMARY OF THE DISCLOSURE

The present disclosure provides a method and apparatus for determining a vertical driving state using a sensor which may determine a gravity change according to a slope of a moving object while being driven, and thereby may determine the vertical driving state using the gravity change.

The present disclosure also provides a method and apparatus for determining a vertical driving state using a sensor which may determine a level driving state or inclining/declining-slope driving state of the moving object more accurately.

According to an aspect of the present disclosure, there is provided a method of determining a driving state, the method including: reading a sensor output signal according to a gravity value of a moving object while being driven, from a sensor which senses a gravity value of the moving object with respect to a direction of gravity; and determining whether the moving object is in a level driving state or inclining/declining-slope driving state by comparing the read sensor output signal with a predetermined reference range.

According to another aspect of the present disclosure, there is provided an apparatus for determining a driving state, the apparatus including: a sensor sensing a gravity value of a moving object while being driven with respect to a direction of gravity; and a determination unit determining whether the moving object is in a level driving state or inclining/declining-slope driving state by comparing a sensor output signal with a predetermined reference range.

According to the present disclosure, a gravity change in a moving object may be determined while being driven, and thus, whether the moving object is in a level driving state or inclining/declining-slope driving state may be determined.

### BRIEF DESCRIPTION OF THE DRAWINGS

FIG. 1 is a block diagram illustrating a configuration of an apparatus for determining a vertical driving state using a sensor according to exemplary embodiment of the present disclosure;

FIG. 2 is a flowchart illustrating a method of determining a vertical driving state using a sensor according to exemplary embodiment of the present disclosure; and

FIG. 3 is a graph illustrating an output signal of an acceleration sensor depending on a driving state of a moving object.

### DETAILED DESCRIPTION OF EXEMPLARY EMBODIMENTS

Hereinafter, a method and apparatus for determining a vertical driving state using a sensor is described in detail by referring to the figures.

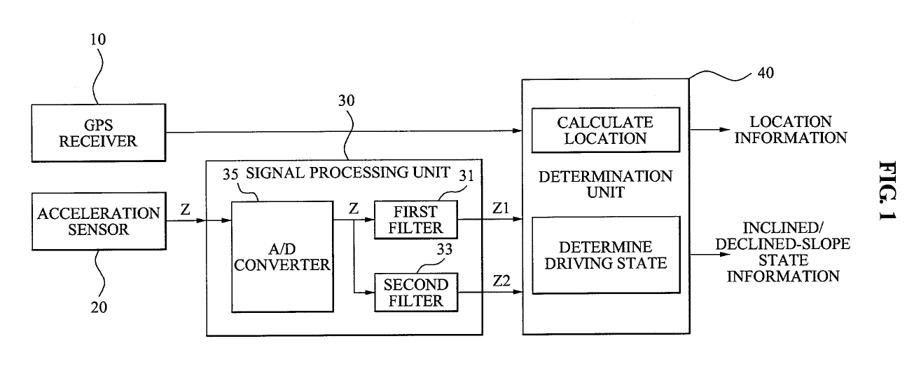

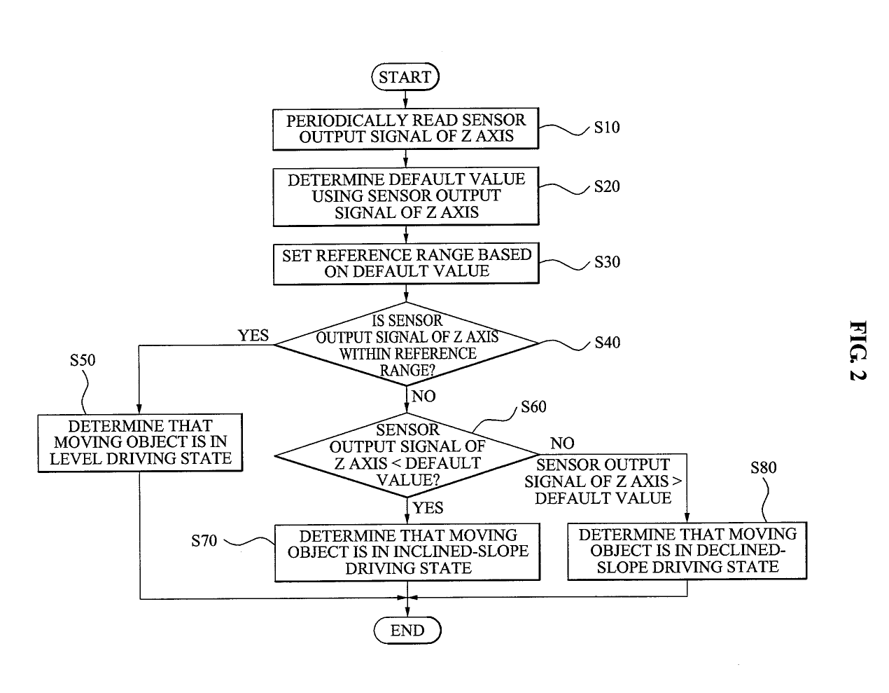

FIG. 1 is a block diagram illustrating a configuration of an apparatus for determining a vertical driving state using a sensor according to exemplary embodiment of the present disclosure, and FIG. 2 is a flowchart illustrating a method of determining a vertical driving state using a sensor according to exemplary embodiment of the present disclosure.

Referring to FIG. 1, a vertical driving state determining apparatus will be described in detail.

The vertical driving state determining apparatus is applied to a navigation device which includes a Global Positioning System (GPS) receiver 10. The GPS receiver 10 receives location signals from at least three GPS satellites, and calculates a location of the GPS receiver 10. The navigation device may be a type of a portable navigation device (PND).

The navigation device may include an acceleration sensor. In this instance, the navigation device may calculate a current location of the moving object using a GPS signal received by the GPS receiver 10. Also, the navigation device may correct the calculated current location based on signals detected by the acceleration sensor, and the like.

The vertical driving state determining apparatus recognizes a gravity change of the moving object by sensing a gravity value of the moving object with respect to a direction of gravity while being driven, and thereby may determine a level driving state or inclining/declining-slope driving state of the moving object.

For this, as illustrated in FIG. 1, the vertical driving state determining apparatus includes a sensor, a signal processing unit 30, and a determination unit 40. The sensor senses the gravity value of the moving object with respect to the direction of gravity. The signal processing unit 30 processes a signal of the sensor. The determination unit 40 determines whether the moving object is in the level driving state or inclining/declining-slope driving state using an output signal of the sensor.

The sensor senses the gravity value of the moving object while being driven. Also, the sensor may include the acceleration sensor 20 used for a location correction in the navigation device.

The acceleration sensor 20 may measure an acceleration value in an X axis, a Y axis, and a Z axis with respect to the moving object. In this instance, the X axis is the same as a horizontal direction of the moving object. The Y axis is the same as a driving direction of the moving object. The Z axis is the same as a vertical direction of the moving object.

The Z axis of the acceleration sensor 20 senses a force in the vertical direction of the moving object. When using the Z axis, a gravity value of the moving object with respect to the direction of gravity, i.e. a vertical axis with respect to a ground surface, may be sensed. Accordingly, the acceleration sensor 20 may be used as a sensor for sensing the gravity value of the moving object.

Accordingly, the acceleration sensor 20 includes at least one sensor axis, and controls the at least one sensor axis to be the same as the vertical direction of the moving object, i.e. the direction of gravity. When the acceleration sensor 20 corresponds to a triaxial acceleration sensor, a sensor output signal of only a Z axis corresponding to the direction of gravity is filtered and used.

According to the present disclosure, only the sensor output signal (hereinafter, Z axis sensor output signal) of the axis corresponding to the vertical direction of the moving object is used when determining the level driving state or inclining/declining-slope driving state of the moving object in order to reduce an effect of an acceleration in the driving direction or the horizontal direction with respect to the gravity value of the moving object while being driven.

Also, since the acceleration sensor 20 outputs an analog signal, the analog signal is required be converted into a digital signal which may be recognized by the determination unit 40. For this, the signal processing unit 30 receives the Z axis sensor output signal of the acceleration sensor 20, and converts the Z axis sensor output signal into the digital signal. Also, the signal processing unit 30 transfers the converted Z axis sensor output signal to the determination unit 40.

The signal processing unit 30 includes an analog to digital (AID) converter 35. The

AID converter 35 converts the Z axis sensor output signal, which is an input signal, into the digital signal which is recognizable by the determination unit. The digital signal corresponds to a level of the analog signal.

According to the present disclosure, whether the moving object is in the level driving state or inclining/declining-slope driving state is determined according to the Z axis sensor output signal. For the determination, a reference range is required to be set for determination of the Z axis sensor output signal.

As a method of setting the reference range, the navigation device is mounted in the moving object when manufacturing the navigation device, and Z axis sensor output signals outputted from the acceleration sensor 20 are collected in a level driving environment. A signal range, which may include all of the Z axis sensor output signals collected, is set as the reference range.

As another method of setting the reference range, besides the above-described method, the reference range is set in real time using the Z axis sensor output signal, outputted from the acceleration sensor 20, while being driven.

For this, two types of filters are used. A filter is used to filter the Z axis sensor output signal for setting the reference range, hereinafter, a first sensor output signal. Another filter is used to filter the Z axis sensor output signal for determining whether the moving object is in the level driving state or inclining/declining-slope driving state, hereinafter, a second sensor output signal.

Specifically, the signal processing unit 30 further includes a first filter 31, and a second filter 33. The first filter 31 filters the first sensor output signal from the Z axis sensor output signal outputted via the A/D converter 35. In this instance, the first sensor output signal has a first response characteristic with respect to the direction of gravity. The second filter 33 filters a second sensor output signal from the Z axis sensor output signal outputted by the A/D converter 35. In this instance, the second sensor output signal has a second response characteristic greater than the first response characteristic.

The first filter 31 and the second filter 33 use the Z axis sensor output signal, outputted from the A/D converter 35, as an input signal, respectively, and apply different response characteristics with respect to the direction of gravity, e.g. different gains, to the Z axis sensor output signal. Accordingly, the first filter 31 and the second filter 33 output and provide the first sensor output signal and the second output sensor signal to the determination unit 40. The first sensor output signal and the second output sensor signal are different from each other.

The determination unit 40 uses the first sensor output signal as a standard for determining a vertical driving state of the moving object. Also, the determination unit 40 uses the second sensor output signal as a standard for determining the level driving state or inclining/declining-slope driving state of the moving object.

In this instance, the driving state of the moving object, which is determined by the determination unit 40, may be used as information when the navigation device calculates the current location of the moving object or when the navigation device guides a user along a path to a destination designated by the user.

Also, it is possible to implement all the control operations of the determination unit 40 using a control unit, without including a separate unit corresponding to the determination unit 40. The control unit includes a path guidance function and controls the overall operations of the navigation device.

A method of determining, by the determination unit 40, a driving state of a moving object using the acceleration sensor 20 will be described in detail with reference to FIG. 2.

Hereinafter, an operation of determining the driving state of the moving object using the first sensor output signal and the second sensor output signal is described. The first sensor output signal and the second sensor output signal are obtained when filtering the Z axis sensor output signal of the acceleration sensor 40 using different response characteristics.

When the moving object is being driven, the Z axis sensor output signal, which is outputted by the acceleration sensor 20 included in the navigation device, is read. The Z axis sensor output signal is converted into a first sensor output signal Z1 and a second sensor output signal Z2, which have different response characteristics, and provided.

In operation S10, when the moving object is being driven, the Z axis sensor output signals, i.e. the first sensor output signal Z1 and the second sensor output signal Z2, are periodically read.

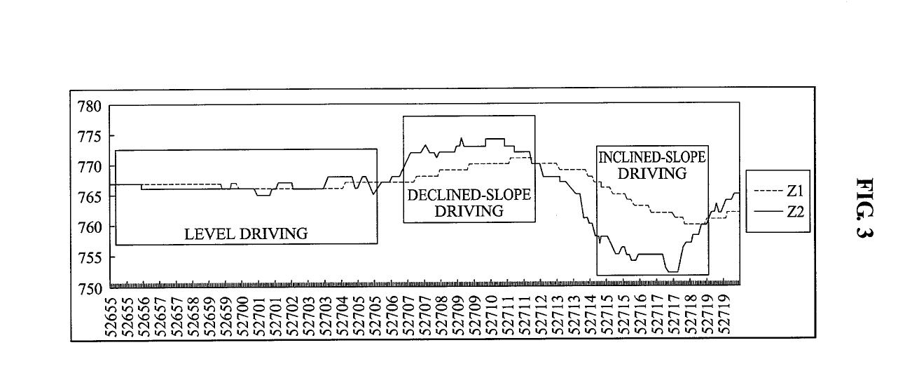

FIG. 3 illustrates a signal measurement result using two filters with respect to a Z axis sensor output signal when a moving object is driven on a road including a level ground, an inclining/declining-slope. The Z axis sensor output signal corresponds to the direction of gravity. The two filters variously apply an output characteristic coefficient with respect to an input, i.e. a response characteristic with respect to gravity. Accordingly, a filter outputs the first sensor output signal Z1 which is relatively insensitive to gravity, whereas another filter outputs the second sensor output signal Z2 which is relatively sensitive to gravity. Specifically, a minute change of force in a vertical axis of the moving object may be recognized using a level difference between the first sensor output signal Z1 and the second sensor output signal Z2 outputted via the different filters.

As illustrated in FIG. 3, in the inclining-slope driving state, for example, when the moving object enters the inclining-slope from the level ground or enters the level ground from the declining-slope, the acceleration sensor 30 shows a pattern in which a sensor value with respect to the vertical axis of the moving object decreases. In the declining-slope driving state, for example, when the moving object enters the declining-slope from the level ground or enters the level ground from the inclining-slope, the acceleration sensor 30 shows a pattern in which the sensor value increases.

The vertical driving state of the moving object may be determined by the signal processing method and sensor feature of the acceleration sensor 20 as described above.

In operation S20, the first sensor output signal Z1 is determined to be a default value from the first sensor output signal Z1 and the second sensor output signal Z2. In this instance, the first sensor output signal Z1 is outputted via a filter having a low response characteristic.

In operation S30, a reference range is set by applying a predetermined ±level based on a signal level of the first sensor output signal Z1. The reference range is to determine the vertical driving state of the moving object, and to reduce a determination error with respect to the driving state of the moving object.

In operation S40, it is determined whether a level value of the second sensor output signal Z2 is within the reference range.

In operation S50, as a result of the determining in operation S40, when the second sensor output signal Z2 has a level value within the reference range, it is determined that a gravity change of the moving object is minute and the moving object is in the level driving state.

Also, when the second sensor output signal Z2 has a level value outside the reference range, it is determined that the moving object is in the inclining/declining-slope driving state.

Here, when a gravity change outside the reference range is sensed in the second sensor output signal Z2, it is determined that the moving object is in the inclining/declining-slope driving state. In this instance, it is required to be ascertained whether the moving object is actually in the inclining-slope driving state or declining-slope driving state.

For this, in operation S60, it is determined that the level value of the second sensor output signal Z2 is greater than a level value of the first sensor output signal Z1.

As a result of the determining in operation S60, in operation S70, when the level value of the second sensor output signal Z2 is less than the level value of the first sensor output signal Z1, it is determined that the moving object is in the inclining-slope driving state. Also, in operation S80, when the level value of the second sensor output signal Z2 is greater than the level value of the first sensor output signal Z1, it is determined that the moving object is in the declining-slope driving state.

Also, when the second sensor output signal Z2 has a level value outside the reference range and has a value which is a positive number when subtracting the first sensor output signal Z1 from the second sensor output signal Z2 (Z2−Z1), it is determined that the moving object is in the declining-slope driving state. When the second sensor output signal Z2 has the level value outside the reference range and has a value which is a negative number when subtracting the first sensor output signal Z1 from the second sensor output signal Z2 (Z2−Z1), it is determined that the moving object is in the inclining-slope driving state.

A determination condition of the inclining/declining-slope driving state may be set to a determination condition opposite to the above-described condition depending on an internal feature of the acceleration sensor 20 or a type of the acceleration sensor 20.

According to the present disclosure, the gravity change of the moving object is accurately determined, and thus it is determined whether the moving object is in the level driving state or inclining/declining-slope driving state.

The exemplary embodiments of the present disclosure include computer-readable media including program instructions to implement various operations embodied by a computer. The media may also include, alone or in combination with the program instructions, data files, data structures, tables, and the like. The media and program instructions may be those specially designed and constructed for the purposes of the present disclosure, or they may be of the kind well known and available to those having skill in the computer software arts. Examples of computer-readable media include magnetic media such as hard disks, floppy disks, and magnetic tape; optical media such as CD ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

According to the present disclosure, a method and apparatus for determining a vertical driving state using a sensor provide information about whether a moving object is in a level driving state or inclining/declining-slope driving state while being driven, using a sensor value corresponding to a vertical axis of an acceleration sensor which is a direction of gravity.

Also, according to the present disclosure, a method and apparatus for determining a vertical driving state using a sensor simply use a sensor signal pattern of a vertical axis of a moving object, i.e. a direction of gravity, and thereby may reduce an effect of acceleration values with respect to the moving object, excluding a vertical direction, when a gravity change is sensed while being driven.

Also, according to the present disclosure, a method and apparatus for determining a vertical driving state using a sensor process sensor values of a vertical axis with different response characteristics, divide a gravity change of a moving object using a change between two signals, and thereby may accurately determine the vertical driving state of the moving object.

Although a few embodiments of the present disclosure have been shown and described, the present disclosure is not limited to the described embodiments. Instead, it would be appreciated by those skilled in the art that changes may be made to these embodiments without departing from the principles and spirit of the present disclosure, the scope of which is defined by the claims and their equivalents.

1. A method of determining a driving state, the method comprising:
reading a sensor output signal according to a gravity value of a moving object while being driven, from a sensor which senses a gravity value of the moving object with respect to a direction of gravity; and
determining whether the moving object is in a level driving state or inclining/declining-slope driving state by comparing the read sensor output signal with a predetermined reference range.

2. The method of claim 1, wherein the sensor includes an acceleration sensor, and controls an axis of the acceleration sensor to be the same as a vertical direction of the moving object, the vertical direction of the moving object corresponding to the direction of gravity.

3. The method of claim 2, wherein the reading comprises periodically reading a sensor output signal of an axis corresponding to the direction of gravity from the acceleration sensor while being driven.

4. The method of claim 2, wherein the determining comprises:
determining that the moving object is in the level driving state when the read sensor output signal with respect to the direction of gravity is within the reference range, and
determining that the moving object is in the inclining-slope driving state or declining-slope driving state when the read sensor output signal is outside the reference range.

5. The method of claim 4, wherein the determining of the level driving state or inclining/declining-slope driving state further comprises setting the reference range based on the read sensor output signal with respect to the direction of gravity.

6. The method of claim 5, wherein the setting comprises:
filtering a first sensor output signal and a second sensor output signal from the sensor output signal, the first sensor output signal and the second sensor output signal having different response characteristics with respect to the direction of gravity, and
setting the reference range having a predetermined range of signal level based on the first sensor output signal.

7. The method of claim 6, wherein a response characteristic of the second sensor output signal is greater than a response characteristic of the first sensor output signal with respect to the direction of gravity.

8. The method of claim 7, wherein the determining of the level driving state determines that the moving object is in the level driving state when the second sensor output signal has a level value within the reference range.

9. The method of claim 7, wherein the determining of the inclining-slope driving state or declining-slope driving state comprises:
determining that the moving object is in the declining-slope driving state when the second sensor output signal has a level value which is outside the reference range and is greater than the first sensor output signal, and
determining that the moving object is in the inclining-slope driving state when the second sensor output signal has the level value which is outside the reference range and is less than the first sensor output signal.

10. A computer-readable recording medium storing a program for implementing the method according to claim 1.

11. An apparatus for determining a driving state, the apparatus comprising:
a sensor sensing a gravity value of a moving object while being driven with respect to a direction of gravity; and
a determination unit determining whether the moving object is in a level driving state or inclining/declining-slope driving state by comparing a sensor output signal with a predetermined reference range.

12. The apparatus of claim 11, wherein the sensor includes an acceleration sensor, and controls a sensor axis of the acceleration axis to be the same as the direction of gravity to sense the gravity value of the moving object.

13. The apparatus of claim 11, further comprising: a signal processing unit converting the sensor output signal into a signal, and outputting the converted sensor output signal to the determination unit, wherein the signal is recognizable by the determination unit.

14. The apparatus of claim 13, wherein the signal processing unit includes an analog to digital (A/D) converter converting the sensor output signal into a digital signal which is recognizable by the determination unit.

15. The apparatus of claim 14, wherein the signal processing unit further comprises a first filter which filters a first sensor output signal from the sensor output signal outputted from the A/D converter, and a second filter which filters a second sensor output signal from the sensor output signal outputted from the A/D converter, the first sensor output signal having a first response characteristic with respect to the direction of gravity, and the second sensor output signal having a second response characteristic greater than the first response characteristic.

16. The apparatus of claim 15, wherein the determination unit sets the reference range based on the first sensor output signal.

17. The apparatus of claim 16, wherein the determination unit determines that the moving object is in the level driving state when the second sensor output signal has a level value which is within the reference range, determines that the moving object is in the declining-slope driving state when the second sensor output signal has a level value which is outside the reference range and is greater than the first sensor output signal, and determines that the moving object is in the inclining-slope driving state when the second sensor output signal has the level value which is outside the reference range and is less than the first sensor output signal.
